(19) United States
(12) Patent Application Publication
(10) Pub. No.: US 2026/0104312 A1
(43) Pub. Date: Apr. 16, 2026

(54) 6DOF PRECISE ALIGNMENT SETUP FOR TWO SENSORS

(71) Applicant: Orbotech Ltd., Yavne (IL)

(72) Inventors: Tal Goichman, Kiryat Ono (IL); Mordechai Hai Hababo, Rosh Ha-Ayin (IL); Ashkan Aghajani, Yavne (IL)

(21) Appl. No.: 18/914,683

(22) Filed: Oct. 14, 2024

(51) Int. Cl. G01M 11/02

(52) U.S. Cl. CPC G01M 11/0221; G01M 11/0214; G01M 11/0257

(57) ABSTRACT

A collection system may include sensors with optical axes which are aligned through a beamsplitter. The sensors may be affixed to printed circuit boards which may in turn be affixed to camera bases. The camera bases may be affixed to static bases through glue layers and blocks. The static bases may extend orthogonally from and may be affixed to the baseplate. Thus, the alignment of the sensors may be maintained by the baseplate through the printed circuit boards, the camera bases, the glue layers, the blocks, and the static bases. The glue layers may also provide six degrees-of-freedom during the alignment before the glue layers are adhered.

### TECHNICAL FIELD

The present disclosure generally relates to beamsplitter systems with sensors and, more particularly, to fixtures for maintaining alignment between the sensors.

### BACKGROUND

Camera sensors may be positioned by passive alignment using mounting holes on printed circuit boards. For more precise variations of the passive alignment, sensor packages are used as positioning feature (e.g., using two straight edges and attaching a mechanical part corner to them). A tilt-tip stage may also be used to align the sensors. Additional alignment may be obtained if there are several mechanical parts that can be moved relative to each other before tightening the screws. Moving the mechanical parts may be performed by adding shims, slightly tapping on loosened parts to move them, or adding push-pull screws to move the parts in more controlled way.

A disadvantage of passive alignment of sensors is that there is no precise correlation between mounting features. Even for relatively precise sensor packages there can be hundreds of micrometers of misalignment between sensors and printed circuit boards. Additionally, when correction methods are used, the corrections are not independent such that crosstalk may occur between the position and orientation. Also, after minor alignment, the tightening action normally produces errors, and must be done again. Therefore, it would be advantageous to provide a device, system, and method that cures the shortcomings described above.

### SUMMARY

A collection system is described, in accordance with one or more embodiments of the present disclosure. The collection system may include: a baseplate; a beamsplitter; a first camera including a first sensor affixed to a first printed circuit board, wherein the first sensor is configured to receive a collected light transmitted by the beamsplitter; a second camera including a second sensor affixed to a second printed circuit board, wherein the second sensor is configured to receive the collected light reflected by the beamsplitter, wherein a first optical axis of the first sensor is aligned relative to a second optical axis of the second sensor through the beamsplitter; a first static base and a second static base, wherein the first static base and the second static base extend orthogonally from and are affixed to the baseplate, wherein the second static base is orthogonal to the first static base; a plurality of blocks; first glue layers, wherein the first glue layers abut between and adhere the plurality of blocks to the first static base and the second static base; a first camera base and a second camera base, wherein the first printed circuit board is affixed to the first camera base, wherein the second printed circuit board is affixed to the second camera base; and second glue layers, wherein the second glue layers abut between and adhere the plurality of blocks to the first camera base and the second camera base.

An optical system is described, in accordance with one or more embodiments of the present disclosure. The optical system may include: a collection system including: a baseplate; a beamsplitter; a first camera including a first sensor affixed to a first printed circuit board, wherein the first sensor is configured to receive a collected light transmitted by the beamsplitter; a second camera including a second sensor affixed to a second printed circuit board, wherein the second sensor is configured to receive the collected light reflected by the beamsplitter, wherein a first optical axis of the first sensor is aligned relative to a second optical axis of the second sensor through the beamsplitter; a first static base and a second static base, wherein the first static base and the second static base extend orthogonally from and are affixed to the baseplate, wherein the second static base is orthogonal to the first static base; a plurality of blocks; first glue layers, wherein the first glue layers abut between and adhere the plurality of blocks to the first static base and the second static base; a first camera base and a second camera base, wherein the first printed circuit board is affixed to the first camera base, wherein the second printed circuit board is affixed to the second camera base; and second glue layers, wherein the second glue layers abut between and adhere the plurality of blocks to the first camera base and the second camera base; and an illumination source configured to generate an illumination beam, wherein the collection system is configured to collect the collected light in response to illuminating a sample with the illumination beam.

A method is described, in accordance with one or more embodiments of the present disclosure. The method may include: aligning a first optical axis of a first sensor relative to a second optical axis of a second sensor through a beamsplitter, wherein the first sensor is affixed to a first printed circuit board, wherein the first printed circuit board is affixed to a first camera base, wherein the first sensor is configured to receive a collected light transmitted by the beamsplitter, wherein the second sensor is affixed to a second printed circuit board, wherein the second sensor is configured to receive the collected light reflected by the beamsplitter, wherein the second printed circuit board is affixed to a second camera base; placing a plurality of blocks on a first static base and a second static base and pressing the plurality of blocks against the first camera base and the second camera base, wherein the first static base and the second static base extend orthogonally from and are affixed to a baseplate, wherein the second static base is orthogonal to the first static base; and adhering first glue layers and second glue layers, wherein the first glue layers abut between and adhere the plurality of blocks to the first static base and the second static base, wherein the second glue layers abut between and adhere the plurality of blocks to the first camera base and the second camera base.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A depicts a top view of a collection system, in accordance with one or more embodiments of the present disclosure.

FIG. 1B depicts a perspective view of the collection system, in accordance with one or more embodiments of the present disclosure.

FIG. 1C depicts a perspective view of the collection system with one or more components which are hidden to illustrate affixing bases via blocks, in accordance with one or more embodiments of the present disclosure.

FIG. 1D depicts a partial perspective view of the collection system with the affixing the bases via the blocks, in accordance with one or more embodiments of the present disclosure.

FIG. 1E depicts a partial side view of the collection system with the affixing the bases via the blocks, in accordance with one or more embodiments of the present disclosure.

FIG. 1F depicts a simplified block diagram of the collection system, in accordance with one or more embodiments of the present disclosure.

FIG. 2 depicts a simplified block diagram of an optical system including the collection system, in accordance with one or more embodiments of the present disclosure.

FIG. 3 depicts a flow diagram of a method, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are directed to six degree-of-freedom (6DOF) precise alignment setup for two sensors. A collection system may include sensors with optical axes which are aligned through a beamsplitter. The sensors may be affixed to printed circuit boards which may in turn be affixed to camera bases. The camera bases may be affixed to static bases through glue layers and blocks. The static bases may extend orthogonally from and may be affixed to the baseplate. Thus, the alignment of the sensors may be maintained by the baseplate through the printed circuit boards, the camera bases, the glue layers, the blocks, and the static bases. The glue layers may also provide six degrees-of-freedom during the alignment before the glue layers are adhered.

U.S. Pat. No. 7,259,869, titled “System and method for performing bright field and dark field optical inspection”; U.S. Pat. No. 7,391,510, titled “System and method for inspecting patterned devices having microscopic conductors”; U.S. Pat. No. 7,714,995, titled “Material independent profiler”; U.S. Pat. No. 8,605,275, titled “Detecting defects on a wafer”; U.S. Pat. No. 8,891,079, titled “Wafer inspection”; U.S. Pat. No. 10,705,026, titled “Scanning differential interference contrast in an imaging system design”; U.S. Pat. No. 10,234,402, titled “Systems and methods for defect material classification”; U.S. Pat. No. 11,159,712, titled “Range differentiators for auto-focusing in optical imaging systems”; U.S. Patent Publication Number US20230408579, titled “Resampling with TDI Sensors”; are each incorporated herein by reference in the entirety.

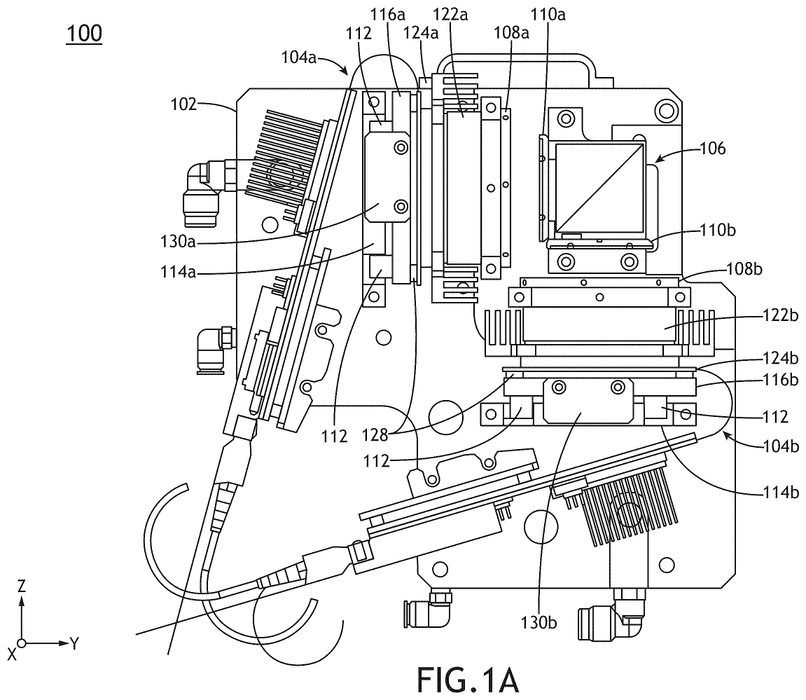

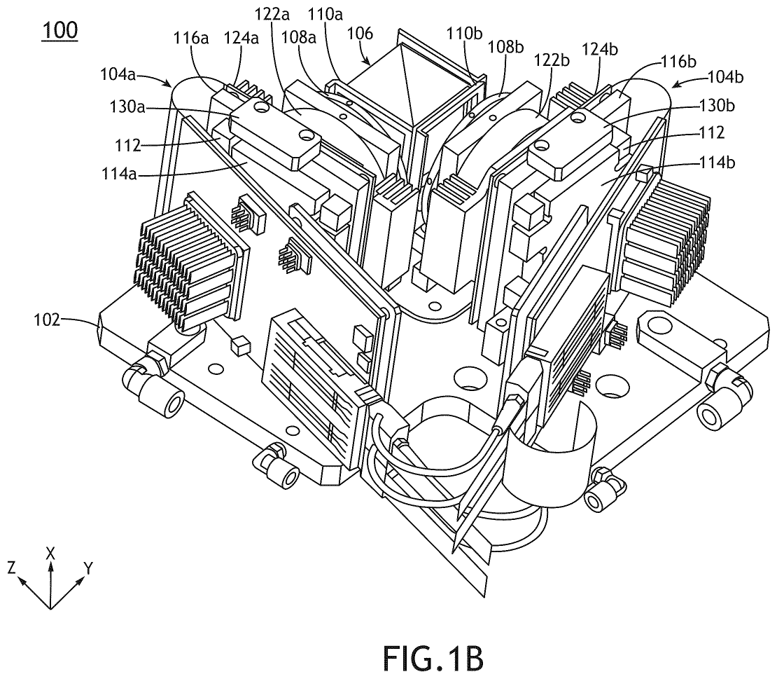

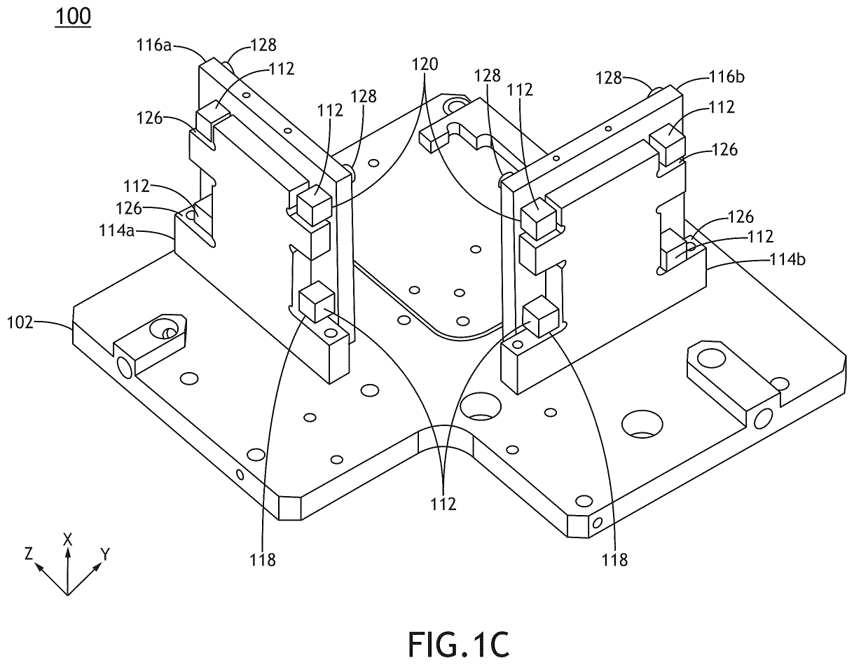

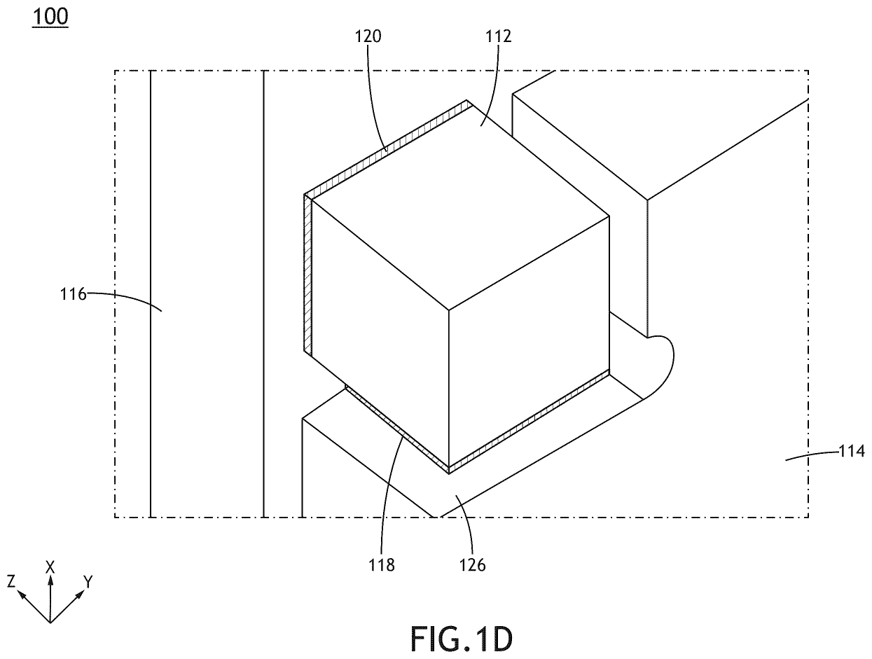

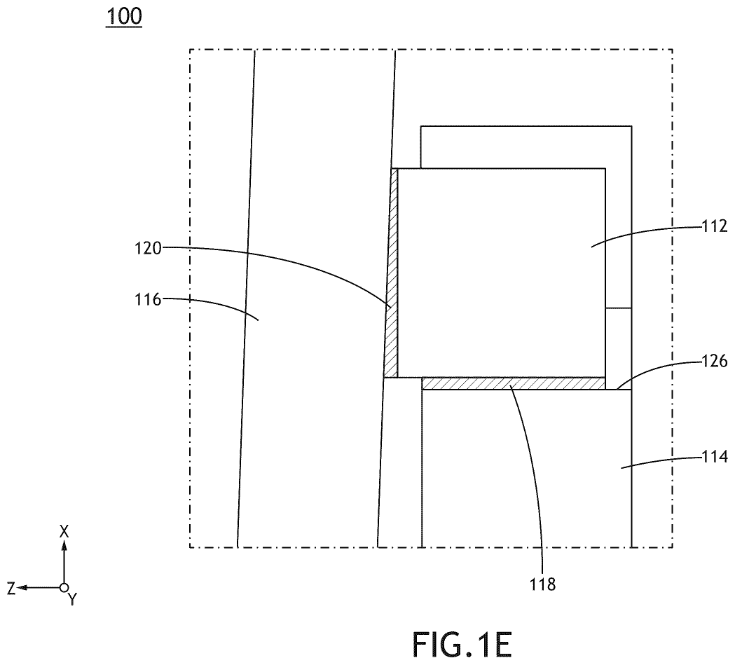

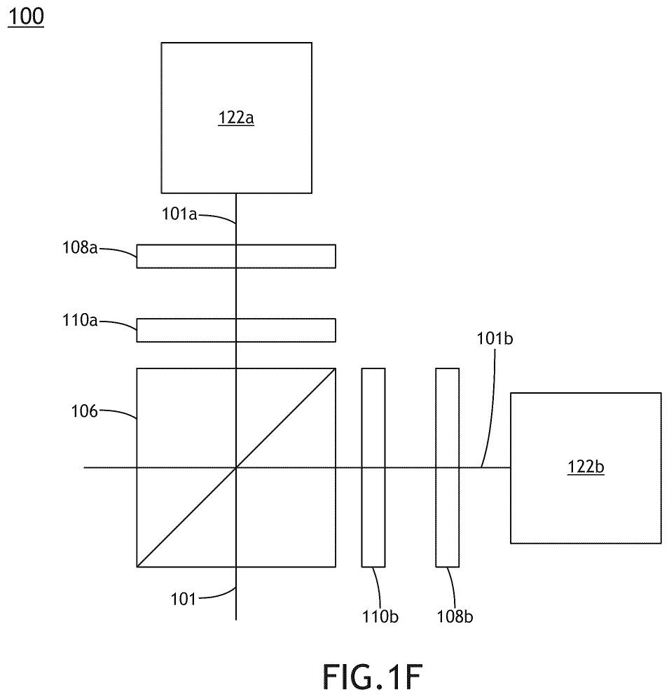

FIGS. 1A-1F depict a collection system 100, in accordance with one or more embodiments of the present disclosure. The collection system 100 may be a field replaceable unit of an optical system 200. The collection system 100 may include a baseplate 102, cameras 104, a beamsplitter 106, polarizers 108, quarter-wave plates 110, blocks 112, static bases 114, camera bases 116, glue layers 118, glue layers 120, and/or ferromagnets 130.

The cameras 104 may be a first camera 104a and a second camera 104b. The cameras 104 may include sensors 122. For example, the first camera 104a and the second camera 104b may include a first sensor 122a and a second sensor 122b, respectively.

The sensors 122 may be configured to receive collected light 101. The collected light 101 received by the sensors 122 may be P-polarized, S-polarized, or circularly-polarized. The sensors 122 may include any type of optical detector configured to generate an image from the collected light 101. The sensors 122 may be point sensors, line sensors, or array sensors. For example, the sensors 122 may include, but are not limited to, a charge-coupled device (CCD) sensor, a time delay integration (TDI) sensor, a photomultiplier tube (PMT), an avalanche photodiode (APD), a complementary metal-oxide-semiconductor (CMOS) sensor, or the like. The sensors 122 may be configured to generate any suitable output, such as images.

The sensors 122 may be configured to receive the collected light 101 from the beamsplitter 106. The beamsplitter 106 may be affixed to the baseplate 102. The beamsplitter 106 may be configured to reflect and/or transmit the collected light 101. The beamsplitter 106 may split the collected light 101 into first collected light 101a and second collected light 101b. The first collected light 101a may be transmitted by the beamsplitter 106. The first collected light 101a transmitted by the beamsplitter 106 may be directed to and received by the first sensor 122a. The second collected light 101b may be reflected by the beamsplitter 106. The second collected light 101b reflected by the beamsplitter 106 may be directed to and received by the second sensor 122b. The first sensor 122a may be orthogonal to the second sensor 122b for receiving the collected light 101 from the beamsplitter 106.

The first collected light 101a and a second collected light 101b may include a select ratio of optical power. For example, the beamsplitter 106 may transmit half and reflect half of the collected light 101 (e.g., the ratio of the first collected light 101a to the second collected light 101b may be 50:50), although this is not intended to be limiting. It is further contemplated, that the beamsplitter 106 may include other reflection/transmission (R/T) ratios.

The beamsplitter 106 may include any suitable beamsplitter, such as, but not limited to, a cube beamsplitter, a plate beamsplitter, or the like. The beamsplitter 106 may be a non-polarizing beamsplitter. The non-polarizing beamsplitter may be configured to transmit and/or reflect the collected light 101.

The cameras 104 may include printed circuit boards 124. For example, the first camera 104a and the second camera 104b may include a first printed circuit board 124a and a second printed circuit board 124b, respectively. The printed circuit boards 124 may provide an input and/or an output to the sensors 122. For example, the printed circuit boards 124 may provide signals, power supply, images, and the like to and/or from the sensors 122. The sensors 122 may be affixed to the printed circuit boards 124. For example, the first sensors 122a may be affixed to the first printed circuit board 124a. By way of another example, the second sensors 122b may be affixed to the second printed circuit board 124b. The sensors 122 may be affixed to a frontside of the printed circuit boards 124. The cameras 104 may include any number of the sensors 122 affixed to the printed circuit boards 124. For example, each of the cameras 104 may include one, two, or more of the sensors 122 affixed to the printed circuit boards 124.

The sensors 122 may be affixed to the printed circuit boards 124 using any suitable technique. For example, the sensors 122 may be affixed to the printed circuit boards 124 by through-hole mounting, surface mounting, or the like. The alignment of the first sensors 122a relative to the first printed circuit board 124a and the alignment of the second sensors 122b relative to the second printed circuit board 124b may include alignment error. The alignment error may be introduced as the sensors 122 are affixed to the printed circuit boards 124. The sensors 122 may maintain the alignment error when the printed circuit boards 124 are aligned relative to each other. The alignment may be the position along any of the mechanical axes (e.g., X, Y, Z) of the collection system 100 and/or the orientation (e.g., ΘX, ΘY, ΘZ) about the mechanical axes.

Instead of aligning the printed circuit boards 124 relative to each other, the first sensor 122a and the second sensor 122b may be aligned relative to each other. The first sensor 122a and the second sensor 122b may be aligned relative to each other to accommodate for the position and/or orientation error of the sensors 122 relative to the printed circuit boards 124. The alignment may occur with six-degrees of freedom along and/or about the mechanical axes. The optical axis of the first sensor 122a relative to the optical axis of the second sensor 122b may be aligned through the beamsplitter 106. The optical axes of the sensors 122 may refer to center pixels of the sensors 122.

The collection system 100 may maintain alignment of the optical axes of the sensors 122 using the baseplate 102, the blocks 112, the static bases 114, the camera bases 116, the glue layers 118, and/or the glue layers 120.

The baseplate 102 may be a structural support for the collection system 100. The baseplate 102 may support the cameras 104, the beamsplitter 106, polarizers 108, quarter-wave plates 110, blocks 112, static bases 114, camera bases 116, glue layers 118, and/or the glue layers 120. The sensors 122 may be supported by the baseplate 102 through the printed circuit boards 124, the camera bases 116, the glue layers 120, the blocks 112, the glue layers 118, and the static bases 114 in sequence. For example, the first sensor 122a may be supported by the baseplate 102 through the first printed circuit board 124a, the first camera base 116a, the glue layers 120, the blocks 112, the glue layers 118, and the first static base 114a in sequence. By way of another example, the second sensor 122b may be supported by the baseplate 102 through the second printed circuit board 124b, the second camera base 116b, the glue layers 120, the blocks 112, the glue layers 118, and the second static base 114b.

The static bases 114 may extend orthogonally from and affix to the baseplate 102. The baseplate 102 and the static bases 114 may or may not be monolithic. For example, the baseplate 102 and the static bases 114 may be a single piece which is not formed of halves or other constituent pieces such that the components are monolithic. By way of another example, the baseplate 102 and the static bases 114 may be separate pieces which are affixed by fasteners, a weld, or the like, such that the components are not monolithic. The static bases 114 may be a first static base 114a and a second static base 114b. The second static base 114b may be orthogonal to the first static base 114a, each of which may be orthogonal to the baseplate 102.

The static bases 114 may include surfaces 126. The surfaces 126 may be aligned in parallel with the baseplate 102. The surfaces 126 may protrude outwards from sides of the static bases 114. The surfaces 126 may protrude from opposing sides of the static bases. The static bases 114 may include any number of the surfaces 126. For example, the static bases 114 may include pairs of the surfaces 126 protruding from opposing sides of the static bases 114.

The camera bases 116 may be affixed to the printed circuit boards 124. The camera bases 116 may be a first camera base 116a and a second camera base 116b. The first camera base 116a and the second camera base 116b may be affixed to the first printed circuit board 124a and the second printed circuit board 124b, respectively. The camera bases 116 may be affixed to a backside of the printed circuit boards 124.

The camera bases 116 may include standoffs 128. The standoffs 128 may affix the printed circuit boards 124 to the camera bases 116. The standoffs 128 may also allow decoupling the printed circuit boards 124 from the camera bases 116. The ability to decouple the printed circuit boards 124 from the camera bases 116 may be beneficial to reuse the cameras 104, the sensors 122, and/or the printed circuit boards 124 when servicing the cameras 104, changing the alignment of the optical axes of the sensors 122, and/or replacing the blocks 112, the static bases 114, and/or the camera bases 116. The standoffs 128 may be on the order of millimeters or centimeters.

The baseplate 102, the static bases 114, and/or the camera bases 116 may be sheets of a material. The baseplate 102, the static bases 114, and/or the camera bases 116 may include lengths, widths, and thicknesses. The thicknesses may be much less than the lengths and/or widths.

The blocks 112 may be adhered to the static bases 114. The glue layers 118 may abut between and adhere the blocks 112 to the static bases 114. For example, the glue layers 118 may abut between and adhere the blocks 112 to respective of the first static base 114a and the second static base 114b. The glue layers 118 abutting between and adhering the blocks 112 to the first static base 114a may be aligned in parallel with the glue layers 118 abutting between and adhering the blocks 112 to the second static base 114b. The blocks 112 may be adhered to the surfaces 126 of the static bases 114. The glue layers 118 may abut between and adhere the blocks 112 to the surfaces 126 of the static bases 114.

The blocks 112 may also be adhered to the camera bases 116. The glue layers 120 may abut between and adhere the blocks 112 to the camera bases 116. For example, the glue layers 120 may abut between and adhere the blocks 112 to respective of the first camera base 116a and the second camera base 116b. The glue layers 120 abutting between and adhering the blocks 112 to the first camera base 116a may be aligned orthogonal to the glue layers 120 abutting between and adhering the blocks 112 to the second camera base 116b.

The camera bases 116 may be disposed between the blocks 112 and the sensors 122 and/or the printed circuit boards 124. For example, the first camera base 116a may be disposed between the blocks 112 to which the first camera base 116a is adhered and the first printed circuit board 124a. By way of another example, the second camera base 116b may be disposed between the blocks 112 to which the second camera base 116b is adhered and the second printed circuit board 124b.

The blocks 112 may affix between the static bases 114 and the camera bases 116. For example, the blocks 112 may affix between the static bases 114 and the camera bases 116 via the glue layers 118 and the glue layers 120.

The glue layers 118 may be orthogonal to the glue layers 120. The glue layers 118 and the glue layers 120 may be adhered to adjacent surfaces on the blocks 112.

The glue layers 118 and the glue layers 120 may be continuous or discontinuous. For example, the glue layers 118 may be discontinuous and separated from the glue layers 120 on the blocks 112 by a gap. The gap between the glue layers 118 and the glue layers 120 may be based on a gap between the static bases 114 and the camera bases 116.

The camera bases 116, the printed circuit boards 124, and/or the sensors 122 may be aligned with six degrees-of-freedom relative to the static bases 114 using the glue layers 118 and/or the glue layers 120. For example, the position of the camera bases 116 may be translated and/or oriented relative to the static bases 114 before adhering the glue layers 118 and/or the glue layers 120. Thus, the static bases 114 and the camera bases 116 may or may not be aligned in parallel. For example, the PCB plate and the vertical plate may not be aligned in parallel due to changing the orientation (ΘX, ΘY, ΘZ).

The glue layers 118 and/or the glue layers 120 may include a thickness. The thickness of the glue layers 118 and/or the glue layers 120 may or may not be the same. The thickness of the glue layers 118 and/or the glue layers 120 may be on the order of micrometers or tens of micrometers. For example, the thickness may be between five and ten micrometers. Minimizing the thickness of the glue layers 118 and/or the glue layers 120 may be beneficial to reduce shifts and/or thermal drifts induced when curing the glue layers 118 and/or the glue layers 120.

The thickness of the glue layers 118 and/or the glue layers 120 may vary along the length and/or width of the glue layers 118 and/or the glue layers 120. In this regard, the faces of the blocks 112 which are adhered to the glue layers 118 may or may not be parallel with the surfaces 126 of the static bases 114. Similarly, the faces of the blocks 112 which are adhered to the glue layers 120 may or may not be parallel with the camera bases 116. Varying the thickness of the glue layers 118 and/or the glue layers 120 along the length and/or width may be beneficial to provide three degrees-of-freedom in the orientation (e.g., ΘX, ΘY, ΘZ).

The blocks 112 may be transparent to a select wavelength of light. For example, the blocks 112 may be transparent to ultraviolet (UV) light. The blocks 112 may be a shape. For example, the blocks 112 may be a cuboid shape. The blocks 112 may be made of any optically-transparent material. For example, the blocks 112 may be made of a UV-clear glass material. In this regard, the blocks 112 may be UV-clear glass blocks.

The glue layers 118 and the glue layers 120 may be referred to as first glue layers and second glue layers, respectively. The glue layers 118 and the glue layers 120 may include any light-curable optical adhesive. For example, the glue layers 118 and the glue layers 120 may be a UV-light curable adhesive such as a urethane acrylate. The glue layers 118 and the glue layers 120 may provide adhesion between any suitable material, such as, but not limited to, metals, glass, and the like. The glue layers 118 and the glue layers 120 may be cured by shining UV-light through the blocks 112. The glue layers 118 and/or the glue layers 120 may also include an epoxy. The epoxy may cure over time after being mixed. For example, the glue layers 118 and/or the glue layers 120 may include the UV-light curable adhesive which is cured via the UV-light and then covered with the epoxy and allowed to cure over time. The epoxy may strengthen the coupling between the blocks 112, the static bases 114, and/or the camera bases 116. The UV-light curable adhesive may allow for rapid curing while the epoxy is curing.

The collection system 100 may include micrometer-level positioning and fixing in space of the sensors 122 which are orthogonal. Adhering the static bases 114 and the camera bases 116 via the blocks 112, the glue layers 118, and/or the glue layers 120 may allow aligning the optical axes of the sensors 122 within select tolerances. The alignment of the optical axes of the sensors 122 may be within select tolerances. Reducing the tolerance of the alignment of the optical axes of the sensors 122 may be beneficial to align the images generated by the sensors 122. The positioning may include a select position tolerance. For example, the optical axis of the first sensor 122a through the beamsplitter 106 may be positioned to within 0.01 mm of the optical axis of the second sensor 122b. The orientation may include a select orientation tolerance. For example, the optical axis of the first sensor 122a through the beamsplitter 106 may be oriented to within 0.3 mRad (e.g., within 0.1 mRad) of the optical axis of the second sensor 122b. Adhering the static bases 114 and the camera bases 116 via the blocks 112, the glue layers 118, and/or the glue layers 120 may improve the optical performance of the cameras 104 by ensuring the cameras 104 are at a precise angle relative to one another. For example, the sensors 122 may maintain precise focus. Additionally, all pixels of the sensors 122 may be used due to overlap in the images generated by the sensors 122 when aligned. The collected light 101 received by the pixels of the sensors 122 may also include a consistent phase by maintaining the alignment.

The baseplate 102, the blocks 112, the static bases 114, the camera bases 116, the glue layers 118, and/or the glue layers 120 may be sacrificial components of the collection system 100. For example, the baseplate 102, the blocks 112, the static bases 114, the camera bases 116, the glue layers 118, and/or the glue layers 120 may be replaced while reusing the cameras 104.

The collection system 100 may include the ferromagnets 130. The ferromagnets 130 may be affixed to edges of the camera bases 116. The ferromagnets 130 may be a first ferromagnet 130a and a second ferromagnet 130b. The first ferromagnet 130a and the second ferromagnet 130b may be affixed to respective edges of the first camera base 116a and the second camera base 116b.

The collection system 100 may be configured for measurement of the collected light 101 using additional optical elements. The collection system 100 may also include one or more additional optical elements, such as, but not limited to, the polarizers 108 and/or the quarter-wave plates 110. The additional optical elements may be affixed to the baseplate 102 and arranged in the optical axis of the collected light 101. The collected light 101 received by the beamsplitter 106 may be circularly-polarized. The polarizers 108 and/or the quarter-wave plates 110 may be configured to polarize the collected light 101, such that the collected light 101 received by the sensors 122 is linearly polarized.

The quarter-wave plates 110 may be at 45 degrees to the optical axis of the illumination beam 208. The quarter-wave plates 110 may circularly polarize the collected light 101. The quarter-wave plates 110 may be a first quarter-wave plate 110a and a second quarter-wave plate 110b. The first quarter-wave plate 110a may be between the first sensor 122a and the beamsplitter 106. The second quarter-wave plate 110b may be between the second sensor 122b and the beamsplitter 106.

The polarizers 108 may be half-wave plates rotated at an angle of 22.5 degrees about the optical axis of the collected light 101. The polarizers 108 may convert the polarization of the collected light 101 to a 45-degree linear polarization. The polarizers 108 may be first polarizers 108a and second polarizers 108b. The first polarizers 108a may be between the first sensor 122a and the first quarter-wave plate 110a. The second polarizers 108b may be between the second sensor 122b and the second quarter-wave plate 110b. The collected light 101 polarized by the first polarizers 108a may be 90 degrees out-of-phase with the collected light 101 polarized by the second polarizers 108b. For example, the first polarizers 108a may be a half-wave plate rotated at an angle of 22.5 degrees and the second polarizers 108b may be a half-wave plate rotated at an angle of −22.5 degrees. Thus, the first collected light 101a received by the first sensor 122a may be either P-polarized or S-polarized, and the second collected light 101b received by the second sensor 122b may be the other of the P-polarized or S-polarized.

Although the collection system 100 is described as including the beamsplitter 106 which is non-polarizing, the polarizers 108, and the quarter-wave plates 110, this is not intended as a limitation of the present disclosure. It is further contemplated that the beamsplitter 106 may be a polarizing beam splitter (PBS) which may split the collected light 101 into P-polarized light and S-polarized light.

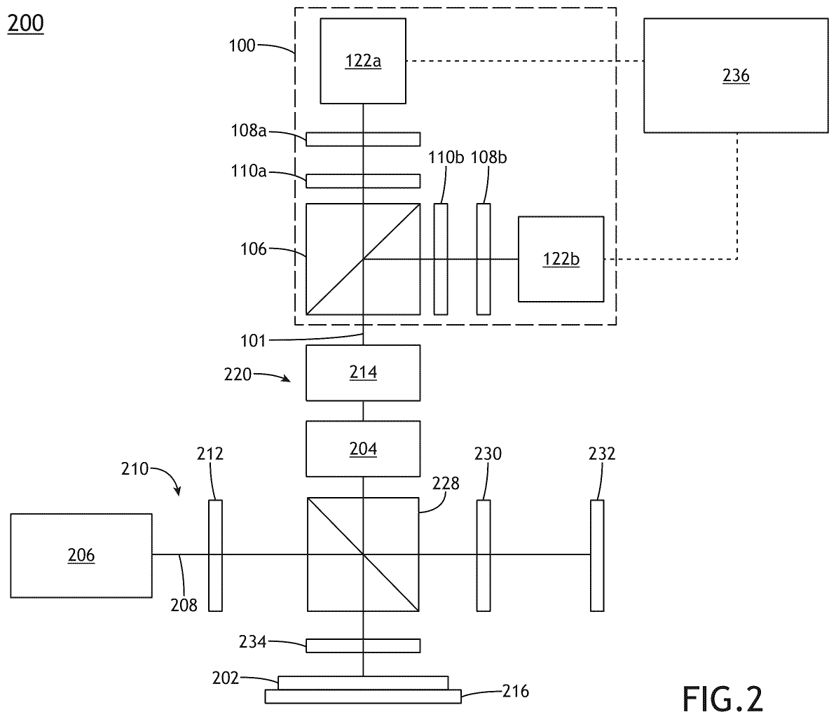

FIG. 2 depicts an optical system 200, in accordance with one or more embodiments of the present disclosure. The optical system 200 may be configured to illuminate a sample 202 with an illumination beam 208 and collect the collected light 101 in response to illuminating the sample 202 with the illumination beam 208. The collection system 100 may be a sub-system of the optical system 200.

The optical system 200 may include an illumination source 206. The illumination source 206 may include any suitable illumination source. For example, the illumination source 206 may be a light-emitting diode (LED), a laser, or the like. The illumination source 206 may include both an LED and laser, other types of light sources, or other combinations of light sources. The illumination source 206 may be a broadband LED. The illumination source 206 may include, but is not limited to, a monochromatic light source (e.g. a laser), a polychromatic light source with a spectrum including two or more discrete wavelengths, a broadband light source, or a wavelength-sweeping light source. Further, the illumination source 206 may be, but is not required to be, formed from a white light source (e.g. a broadband light source with a spectrum including visible wavelengths), a laser source, a free-form illumination source, a single-pole illumination source, a multi-pole illumination source, an arc lamp, an electrode-less lamp, or a laser-sustained plasma (LSP) source.

The illumination source 206 may be configured to generate an illumination beam 208. The illumination beam 208 may include one or more selected wavelengths of light including, but not limited to, vacuum ultraviolet (VUV) radiation, deep ultraviolet (DUV) radiation, ultraviolet (UV) radiation, visible radiation, or infrared (IR) radiation. The spectrum of the illumination beam 208 may be tunable. In this regard, the wavelengths of radiation of the illumination beam 208 may be adjusted to any selected wavelength of radiation (e.g. UV radiation, visible radiation, infrared radiation, or the like). The polarization of the illumination beam 208 may be P-polarized, S-polarized, or circularly polarized. P-polarization may refer to polarization parallel to the incident plane. S-polarization may refer to polarization perpendicular to the incident plane.

The illumination source 206 may direct the illumination beam 208 to the sample along an illumination pathway 210. The illumination pathway 210 may include beam conditioning elements 212. The beam conditioning elements 212 may modify and/or condition the illumination beam 208. For example, the beam conditioning elements 212 may include, but are not limited to, polarizers, filters, beam splitters, diffusers, homogenizers, apodizers, or beam shapers. For instance, the beam conditioning elements 212 may include a polarizer. The polarizer may be configured to adjust the polarization of the illumination beam 208 between 0 and 45 degrees. The polarizer may adjust the polarization for determining a ratio of a sample beam to a reference beam. The beam conditioning elements 212 may also focus the illumination beam 208. For example, the beam conditioning elements 212 may include one or more illumination pathway lenses for controlling one or more characteristics of the illumination beam 208. The beam conditioning elements 212 may provide an optical relay (e.g. a pupil relay, or the like), modify the diameter of the illumination beam 208 (e.g., condense the illumination beam 208, collect the illumination beam 208), or the like.

The optical system 200 may include a sample stage 216. The sample stage 216 may secure and/or position the sample 202. The sample stage 216 may include any type of stage known in the art for positioning a sample 202 including, but not limited to, a linear translation stage, a rotational translation stage, or a translation stage with adjustable tip and/or tilt.

The optical system 200 may include a beamsplitter 228. The beamsplitter 228 may be oriented such that illumination beam 208 may be directed to the sample 202 and a sample beam from the sample 202 may be collected. The illumination beam 208 may reflect, scatter, and/or diffract from the sample 202 as the sample beam. The beamsplitter 228 may be a polarizing beamsplitter (PBS). The polarizing beamsplitter may split light into P-polarized and S-polarized light. For example, the polarizing beamsplitter may transmit P-polarized and reflect S-polarized light, or vice-versa. Thus, the beamsplitter 228 may transmit and reflect the illumination beam 208 with linear polarizations.

The optical system 200 may include a sample polarizer 234. The sample polarizer 234 may be disposed between the beamsplitter 228 and the sample 202. The sample polarizer 234 may receive the illumination beam 208 from the beamsplitter 228 with the linear polarization. The sample polarizer 234 may be a quarter-wave plate at 45 degrees to the optical axis of the illumination beam 208. The sample polarizer 234 may circularly polarize the illumination beam 208 towards the sample 202. The sample 202 may reflect, scatter (e.g., via specular reflection, diffuse reflection, and the like) or diffract a sample beam from the sample 202 in response to the illumination beam 208. The sample beam may then transmit through the beamsplitter 228 towards the objective lens 204.

The optical system 200 may include the collection system 100. The sensors 122 may be configured to receive the collected light 101 from the sample 202 through a collection pathway 220. For example, the sensors 122 may receive an image of the sample 202 via the collected light 101 provided through the optical elements in the collection pathway 220.

The optical system 200 may include an objective lens 204 in the collection pathway 220. The objective lens 204 may collect the collected light 101. The collected light 101 may include the sample beam from the sample 202 and/or a reference beam from a reference mirror 232. The objective lens 204 may be a focusing element to collect the collected light 101. The objective lens 204 may scan towards and away from the sample 202. Scanning the objective lens 204 may change a focus of the images generated by the sensors 122 based on the sample beam and the reference beam.

The collection pathway 220 may further include any number of optical elements to direct and/or modify the sample beam and/or the reference beam collected by the objective lens 204 including, but not limited to, collection optics 214, filters, polarizers, beam blocks, imaging apertures, folding mirrors, or the like. The optical elements may be disposed between the beamsplitter 228 and the objective lens 204 and/or between the objective lens 204 and the beamsplitter 106. The collection optics 214 may include a tube lens that forms an image on the sensors 122 and has a desired magnification. The tube lens may provide high magnification optics. The tube lens may include spherical positive and negative lenses, abortion compensation optics, zoom mechanisms, and/or other components that translate images to the sensors 122.

The optical system 200 may include a reference polarizer 230 and a reference mirror 232. The beamsplitter 228 may transmit a portion of the illumination beam 208 through the reference polarizer 230 to the reference mirror 232. The reference polarizer 230 may receive the illumination beam 208 from the beamsplitter 228 with the linear polarization. The reference polarizer 230 may be a quarter-wave plate at 45 degrees to the optical axis of the illumination beam 208. The reference polarizer 230 may circularly polarize the illumination beam 208 towards the reference mirror 232. The reference mirror 232 may reflect the illumination beam 208 through the reference polarizer 230 and the beamsplitter 228 to form a reference beam. The reference beam may reflect from the beamsplitter 228 towards the objective lens. The beamsplitter 228 may reflect the reference beam through the collection pathway 220 onto the sensors 122. The reference beam may recombine and interfere with the sample beam from the sample 202 in the collection pathway 220 to form the collected light 101. The position of the reference mirror 232 may be scanned towards and away from the beamsplitter 228. By scanning the position of the reference mirror 232, the phase of the reference beam reflected from the reference mirror 232 may be adjusted thereby changing the interference with the sample beam from the sample 202. The reference mirror 232 may use the adjustment to the phase of the reference beam to stabilize a phase drift of the illumination source 206 over time.

The optical system 200 may include a controller 236. The controller 236 may include one or more processors configured to execute program instructions maintained on memory medium. In this regard, the one or more processors of the controller 236 may execute any of the various process steps described throughout the present disclosure.

The controller 236 may be configured to receive data including, but not limited to, images from the sensors 122. The controller 236 may receive the images from the sensors 122. The controller 236 may scan the objective lens 204, the beam conditioning elements 212, the reference mirror 232, and the like. The controller 236 may be configured to perform a three-dimensional (3D) scan of the sample 202. The controller 236 may perform the 3D scan by scanning the objective lens 204 and/or the reference mirror 232. The controller 236 may provide nanometer level synchronization between the objective lens 204 and the reference mirror 232 when scanning. The controller 236 may be configured to perform metrology and/or optical inspection of the sample 202 using interferometry.

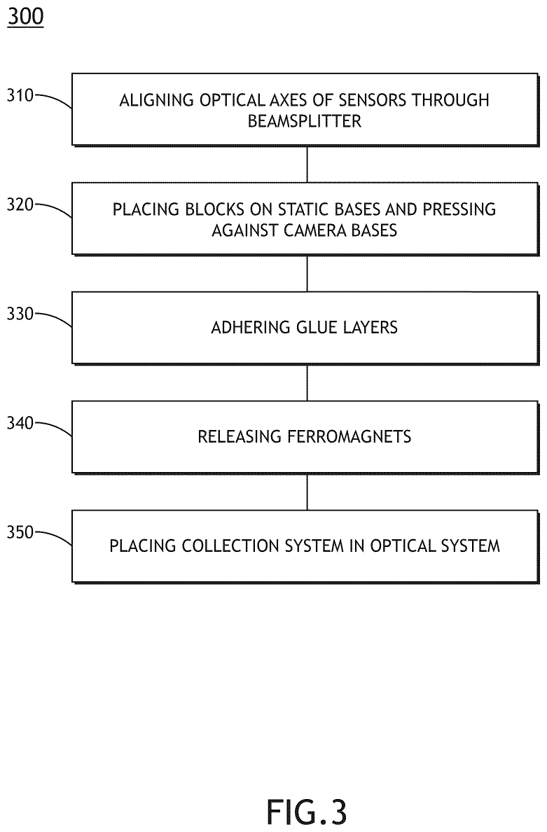

FIG. 3 depicts a flow diagram of a method 300, in accordance with one or more embodiments of the present disclosure. The embodiments and the enabling technologies described previously herein in the context of the collection system 100 should be interpreted to extend to the method 300. It is further noted, however, that the method 300 is not limited to the architecture of the collection system 100.

In a step 310, optical axes of sensors may be aligned through a beamsplitter. For example, the optical axis of the second sensor 122b relative to the optical axis of the first sensor 122a may be aligned through the beamsplitter 106.

The optical axes may be aligned using positioners (not depicted). The ferromagnets 130 may enable magnetically coupling the camera bases 116 with the positioners. The positioners may be affixed to the ferromagnets 130 and configured to align the sensors 122 by moving the ferromagnets 130, the camera bases 116, the printed circuit boards 124, and the sensors 122. The positioners may move the ferromagnets 130, the printed circuit boards 124, and the sensors 122 as one unit when aligning the sensors 122. A first positioner may be affixed to the first ferromagnet 130a and configured to align the first sensor 122a. A second positioner may be affixed to the second ferromagnet 130b and configured to align the second sensor 122b. The positioners may be six degree-of-freedom positioners configured to align the sensors 122 across all six degrees-of-freedom. The positioners may provide independent position (e.g., X, Y, Z) and orientation (e.g., ΘX, ΘY, ΘZ) about the optical axis of the sensors 122 (e.g., central pixel). No cross-talk may occur between the position and orientation when aligning the sensors 122. Thus, each of the position and orientation may be precisely aligned.

The positioners may be manual or motorized. The positioners may include any suitable positioners, such as, but not limited to, towers, hexapod stages, manipulators, or the like. The positioners may be magnetically coupled to the ferromagnets 130 with a releasable magnet. The releasable magnet may include a mechanical release via translation, an electromagnet, or the like. The positioners may hold the sensors 122 in position until the sensors 122 are released from the positioners.

The sensors 122 may be actively aligned using feedback. The feedback may indicate how to align the sensors 122. The alignment of the sensors 122 may be measured using an autocollimator (not depicted), or the like. The autocollimator may provide feedback to the positioners. For example, the autocollimator may provide optical feedback to tell how much and in which degrees to the move the sensors 122. The positioners and/or the autocollimator may be housed within a jig (not depicted). The alignment of the sensors 122 may also be performed using illumination projection and/or using Moiré/interferometric alignment between the sensors 122.

In a step 320, blocks may be placed on static bases and pressed against camera bases. For example, the blocks 112 may be pressed against the static bases 114 and the camera bases 116. The blocks 112 may be pressed on the surfaces 126 of the static bases 114. The surfaces 126 may be a horizontal surface when pressing the blocks 112. The camera bases 116 may be a vertical surface when pressing the blocks 112. After placement and before adhesion of the glue layers 118 and the glue layers 120, the blocks 112 may be held by gravity on the surfaces 126.

The glue layers 118 and/or the glue layers 120 may be applied to the blocks 112, the static bases 114, and/or the camera bases 116 before pressing the blocks 112 on the static bases 114 and/or the camera bases 116. The glue layers 118 may be between the blocks 112 and the static bases 114 when pressing the blocks 112 against the bases. The glue layers 120 may be between the blocks 112 and the on the camera bases 116 when pressing when pressing the blocks 112 against the bases. Pressing the blocks 112 against the static bases 114 and the camera bases 116 may reduce the thickness of the glue layers 118 and the glue layers 120, respectively. The arrangement of the collection system 100 allows the blocks 112 to slide and adapt to mutual lateral and angular misalignments between the blocks 112, the static bases 114, and/or the camera bases 116 induced during alignment of the sensors 122.

In a step 330, the glue layers may be adhered. For example, the glue layers 118 and the glue layers 120 may be adhered. The glue layers 118 may be abut between and adhere the blocks 112 to the static bases 114. The glue layers 120 abut between and adhere the blocks 112 to the camera bases 116. The glue layers 118 and/or the glue layers 120 may be adhered by curing under ultraviolet light, where the glue layers are UV-curable.

The positioners may maintain the coupling with the ferromagnets 130 as the blocks 112 are pressed against the static bases 114 and the camera bases 116 and may maintain the coupling as the glue layers 118 and/or the glue layers 120 are adhered.

In a step 340, the positioners may release from the ferromagnets. For example, the positioners may release from the ferromagnets 130. The positioners may release from the ferromagnets 130 once the glue layers 118 and the glue layers 120 are adhered. The sensors 122 are now supported by the baseplate 102 through the printed circuit boards 124, the camera bases 116, the glue layers 120, the blocks 112, the glue layers 118, and the static bases 114.

In a step 350, the collection system may be placed in the optical system. For example, the collection system 100 may be placed in the optical system 200. The alignment of the sensors 122 may be preserved during curing of the glue layers, after the positioners are released, and the collection system 100 is placed in the optical system 200.

Referring generally again to the figures. A controller may include one or more controllers housed in a common housing or within multiple housings. In this way, any controller or combination of controllers may be separately packaged as a module suitable for integration into a system. Further, the controllers may analyze data received from detectors and feed the data to additional components within the system or external to the system.

The one or more processors may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). In one embodiment, the one or more processors may be embodied as a desktop computer, mainframe computer system, workstation, image computer, parallel processor, networked computer, or any other computer system configured to execute a program configured to operate or operate in conjunction with the systems, as described throughout the present disclosure

The memory medium may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a magnetic tape, a solid-state drive and the like. It is further noted that memory medium may be housed in a common controller housing with the one or more processors. In one embodiment, the memory medium may be located remotely with respect to the physical location of the one or more processors and controller. For instance, the one or more processors of controller may access a remote memory (e.g., server), accessible through a network (e.g., internet, intranet and the like).

It is further contemplated that each of the embodiments of the methods described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, the terms “parallel” and “orthogonal” are intended to include a maximum tolerance up to which objects may be parallel or orthogonal to each other. The maximum tolerance may be 0.5 degrees.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A collection system comprising:
a baseplate;
a beamsplitter;
a first camera comprising a first sensor affixed to a first printed circuit board, wherein the first sensor is configured to receive a collected light transmitted by the beamsplitter;
a second camera comprising a second sensor affixed to a second printed circuit board, wherein the second sensor is configured to receive the collected light reflected by the beamsplitter, wherein a first optical axis of the first sensor is aligned relative to a second optical axis of the second sensor through the beamsplitter;
a first static base and a second static base, wherein the first static base and the second static base extend orthogonally from and are affixed to the baseplate, wherein the second static base is orthogonal to the first static base;
a plurality of blocks;
first glue layers, wherein the first glue layers abut between and adhere the plurality of blocks to the first static base and the second static base;
a first camera base and a second camera base, wherein the first printed circuit board is affixed to the first camera base, wherein the second printed circuit board is affixed to the second camera base; and
second glue layers, wherein the second glue layers abut between and adhere the plurality of blocks to the first camera base and the second camera base.

2. The collection system of claim 1, wherein the first sensor and the second sensor are optical detectors configured to generate images from the collected light.

3. The collection system of claim 1, wherein the first sensor is one of a plurality of sensors affixed to the first printed circuit board.

4. The collection system of claim 1, wherein the first sensor is supported by the baseplate through the first printed circuit board, the first camera base, the first glue layers, the plurality of blocks, and the second glue layers, and the first static base in sequence.

5. The collection system of claim 1, wherein the first static base and the second static base comprise a plurality of surfaces, wherein the plurality of surfaces protrude outwards from sides of the first static base and the second static base, wherein the plurality of blocks are adhered to the plurality of surfaces.

6. The collection system of claim 5, wherein the plurality of surfaces are aligned in parallel with the baseplate.

7. The collection system of claim 1, wherein the first glue layers are orthogonal to the second glue layers.

8. The collection system of claim 1, wherein a thickness of the first glue layers varies along at least one of a length or width of the first glue layers.

9. The collection system of claim 1, wherein a thickness of the second glue layers varies along at least one of a length or width of the second glue layers.

10. The collection system of claim 1, wherein the plurality of blocks are transparent to ultraviolet light, wherein the first glue layers and the second glue layers comprise a UV-light curable adhesive.

11. The collection system of claim 1, wherein at least one of the first glue layers or the second glue layers comprise an epoxy.

12. The collection system of claim 1, wherein the plurality of blocks comprise a cuboid shape.

13. The collection system of claim 1, wherein the first optical axis of the first sensor through the beamsplitter is positioned to within 0.01 mm of the second optical axis of the second sensor.

14. The collection system of claim 1, wherein the first optical axis of the first sensor through the beamsplitter is oriented to within 0.3 mRad of the second optical axis of the second sensor.

15. The collection system of claim 1, comprising a first ferromagnet and a second ferromagnet, wherein the first ferromagnet and the second ferromagnet are affixed to respective edges of the first camera base and the second camera base.

16. The collection system of claim 1, wherein the collected light received by the first sensor is one of P-polarized or S-polarized, wherein the collected light received by the second sensor is the other of P-polarized or S-polarized.

17. The collection system of claim 16, wherein the beamsplitter is a non-polarizing beamsplitter.

18. The collection system of claim 17, comprising a first polarizer, a second polarizer, a first quarter-wave plate, and a second quarter-wave plate, wherein the first quarter-wave plate is between the first sensor and the beamsplitter, wherein the second quarter-wave plate is between the second sensor and the beamsplitter, wherein the first polarizer is between the first sensor and the first quarter-wave plate, wherein the second polarizer is between the second sensor and the second quarter-wave plate.

19. An optical system comprising:
a collection system comprising:
a baseplate;
a beamsplitter;
a first camera comprising a first sensor affixed to a first printed circuit board, wherein the first sensor is configured to receive a collected light transmitted by the beamsplitter;
a second camera comprising a second sensor affixed to a second printed circuit board, wherein the second sensor is configured to receive the collected light reflected by the beamsplitter, wherein a first optical axis of the first sensor is aligned relative to a second optical axis of the second sensor through the beamsplitter;
a first static base and a second static base, wherein the first static base and the second static base extend orthogonally from and are affixed to the baseplate, wherein the second static base is orthogonal to the first static base;
a plurality of blocks;
first glue layers, wherein the first glue layers abut between and adhere the plurality of blocks to the first static base and the second static base;
a first camera base and a second camera base, wherein the first printed circuit board is affixed to the first camera base, wherein the second printed circuit board is affixed to the second camera base; and
second glue layers, wherein the second glue layers abut between and adhere the plurality of blocks to the first camera base and the second camera base; and
an illumination source configured to generate an illumination beam, wherein the collection system is configured to collect the collected light in response to illuminating a sample with the illumination beam.

20. A method comprising:
aligning a first optical axis of a first sensor relative to a second optical axis of a second sensor through a beamsplitter, wherein the first sensor is affixed to a first printed circuit board, wherein the first printed circuit board is affixed to a first camera base, wherein the first sensor is configured to receive a collected light transmitted by the beamsplitter, wherein the second sensor is affixed to a second printed circuit board, wherein the second sensor is configured to receive the collected light reflected by the beamsplitter, wherein the second printed circuit board is affixed to a second camera base;
placing a plurality of blocks on a first static base and a second static base and pressing the plurality of blocks against the first camera base and the second camera base, wherein the first static base and the second static base extend orthogonally from and are affixed to a baseplate, wherein the second static base is orthogonal to the first static base; and
adhering first glue layers and second glue layers, wherein the first glue layers abut between and adhere the plurality of blocks to the first static base and the second static base, wherein the second glue layers abut between and adhere the plurality of blocks to the first camera base and the second camera base.
